(19) United States
(12) Patent Application Publication
(10) Pub. No.: US 2013/0326047 A1
(43) Pub. Date: Dec. 5, 2013

(54) ROUTER AND PERSONAL DEVICE FOR MONITORING AND CONTROLLING DATA TRANSFER RATES ON A LOCAL AREA NETWORK

(71) Applicant: Allen Easty, Katy, TX (US)

(72) Inventor: Allen Easty, Katy, TX (US)

(73) Assignee: MESH NETWORKS, LLC, Houston, TX (US)

(21) Appl. No.: 13/483,794

(22) Filed: May 30, 2012

(51) Int. Cl. G06F 15/173; H04W 24/00

(52) U.S. Cl. 709/224

(57) ABSTRACT

A router configured to monitor data transfer to devices on a local area network can include computer instructions for identifying the devices on the local area network, monitoring the data transfer rates for each of the devices, controlling the data transfer rates for each of the devices, and for communicating with a personal device. The personal device can be configured to display the monitored data transfer rates to a user and allow the user to control the data transfer rates for each device.

### FIELD

The present embodiments generally relate to a router configured to monitor network traffic on a home network and a personal device configured to communicate with the router to control the network traffic.

### BACKGROUND

A need exists for a router configured to monitor network traffic on a home network and for a personal device configured to communicate with the router to control the network traffic.

A further need exists for a router and a personal device to communicate with the router, wherein the personal device can display the network traffic for each device on the network, set priorities for the local area network, set QoS (Quality of Service) rates for each device, or combinations thereof.

A further need exists for a router and a personal device that communicates with the router, wherein the personal device can display sites visited for each device on the network, alerts when a specific device is activated, or combinations thereof.

The present embodiments meet these needs.

### BRIEF DESCRIPTION OF THE DRAWINGS

The detailed description will be better understood in conjunction with the accompanying drawings as follows:

FIG. 1 depicts a schematic of a system with a router configured to monitor traffic on a network and two personal devices configured to communicate with the router according to one or more embodiments.

FIG. 2 depicts a schematic of a personal device configured to communicate with a router according to one or more embodiments.

FIG. 3 depicts a schematic of a router configured to monitor traffic on a network according to one or more embodiments.

FIG. 4 depicts a schematic of a personal device display area according to one or more embodiments.

FIG. 5 depicts a schematic of a personal device display area depicting real time traffic in a sliding window display according to one or more embodiments.

FIG. 6 depicts a schematic of another embodiment of the personal device display area according to one or more embodiments.

FIG. 7 depicts a schematic of yet another embodiment of the personal device display area according to one or more embodiments.

FIG. 8 depicts the display showing a list of web addresses for a given device.

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

The present embodiments generally relate to a router configured to monitor network traffic on a home network and a personal device configured to communicate with the router to control the network traffic.

The router configured to monitor the network traffic on a home network can include computer instructions for detecting the presence of a device on a wired and wireless local area network. The router configured to monitor the network traffic on a home network can also include computer instructions for capturing an Internet Protocol (IP) address and Media Access Control (MAC) address for the device on the local area network. The router configured to monitor the network traffic on a home network can include computer instructions for tracking and monitoring changes to IP addresses for the device. The computer instructions for tracking and monitoring changes to IP addresses for the device can instruct the processor to detect the current state of the Address Resolution Protocol (ARP) table, compare to a previous ARP table state and the Dynamic Host Configuration Protocol (DHCP) lease file to determine changes to IP addresses for the device.

The computer instructions for detecting the presence of a device on a wired and wireless local area network, the computer instructions for capturing an IP address and MAC address for the device on the local area network, and the computer instructions for tracking and monitoring changes to IP addresses for the device can work with one another to instruct a processor of the router to monitor an ARP table. The ARP table state is examined to determine changes in the client device set. For example, the ARP table can be examined to detect new MAC addresses, which are new devices. If two entries (with different IPs) appear for the same MAC, checking against the previous ARP sample can determine which IP address is the new IP address in the event of an address change. If there is no previous sample (at turn on or restart) the DHCP lease file is examined for a tip. If DHCP isn't assigning addresses automatically due to a failure, then the processor can be instructed to wait for the old entry to age out.

The router configured to monitor the network traffic on a home network can include computer instructions for extracting a host name associated with the device.

The computer instructions for extracting a host name associated with the device can instruct the processor to monitor that DHCP leases file and extract the host name for each device on the network. The computer instructions for extracting the host name associated with the device can also instruct the processor to associate the host name for each device with the IP and MAC addresses for each device. For example, the computer instructions can instruct the processor to examine the leases file for entries matching the MAC address of a device for the most recent non-blank host name entry.

The router configured to monitor the network traffic on a home network can include computer instructions to extract other pertinent identifying information.

The computer instructions to extract other pertinent identifying information can instruct the processor to capture outgoing Hypertext Transfer Protocol (HTTP) requests from the devices on the network. The type of device, the operating system used by the device, and the browser type of the device can be captured and stored. This information can be captured by examining the user agent of outgoing HTTP requests. For example, one or more devices can be selected for the processor to receive the HTTP request for, the devices can be selected using the user interface, and these computer instructions can instruct the processor to examine an Ethernet or 802.11 header of the outgoing request packets to obtain the MAC address of the device and extract the HTTP requests. The User Agent header of the HTTP request has the information from which the device type, OS, & browser type can be deduced or extracted.

The router configured to monitor the network traffic on a home network can include computer instructions to monitor the incoming data rates to the device.

The computer instructions to monitor the incoming data rates to the device can instruct the processor to determine the data rate being transferred to each device on the network. The computer instructions can be configured to set up a three tier hash table for scalably sorting traffic by device. When a new device is added to the system a new queue, with no QoS rate values and default priority, is established, and an associated leaf entry added to the hash table. Packets are sorted by the hash table and pass through the queue which serves as a simple byte counting mechanism before QoS is applied.

The router configured to monitor the network traffic on a home network can include computer instructions for monitoring the outgoing data rates for the device. The computer instructions for monitoring the outgoing data rates for the device can instruct the processor to determine the data rate being transferred from each device on the network. These computer instructions can function substantially similar to the computer instruction to monitor the incoming data rates to the device can instruct the processor to determine the data rate being transferred to each device on the network.

The router configured to monitor the network traffic on a home network can include computer instructions for controlling incoming data rates to, and outgoing data rates from, the device.

The computer instructions for controlling incoming data rates to and outgoing data rates from the device can instruct the processor to acquire the data rates from the computer instructions for monitoring the outgoing data rates for the device and the computer instructions for monitoring incoming data for the each device, and apply a QoS to control the data rates. Queues are maintained for the traffic of each device. The servicing of those queues is managed by one of several algorithms capable of supporting the desired QoS strategy. In this case the QoS strategies are bandwidth caps and minimums; and relative priority of traffic. Queue management algorithms include Hierarchical Token Bucket and Stochastic Fairness Queuing.

The router configured to monitor the network traffic on a home network can include computer instructions for speaking with a personal device having a software package thereon, wherein the software package enables the mobile device to control and monitor, monitoring the outgoing data rates for each device and the incoming data for each device. These computer instructions can instruct the processor to communicate with a personal data device and transmit the monitored incoming data rates and outgoing data rates for each device to the personal device, and to receive input from the personal device to control the allowable data rates for each device.

The router configured to monitor the network traffic on a home network can include computer instructions for capturing the outgoing HTTP requests made by the device.

The computer instructions for capturing the outgoing HTTP requests made by the device can instruct the processor to capture outgoing web addresses from each device on the network by examining the request and host HTTP requests. For example, the HTTP request contains the destination address and host. Together they form the URL (Uniform Resource Locator) or “web address.” And the computer instructions for capturing the outgoing HTTP requests made by the device can instruct the processor to capture outgoing web addresses from each device on the network by examining the request to identify the host for the request, then the processor can track the host portion to identify the destination portion, i.e. device, and the computer instructions can instruct the processor to associate the host with the device in a report or table.

The router configured to monitor the network traffic on a home network can include computer instructions to capture signal events.

The computer instructions to capture signal events can instruct the processor to capture signal events such as when a device on the network is activated. For example, when a child comes home from school and begins surfing from a computer or playing an online game on a console, these computer instructions can instruct the processor to identify when a specific device is activated and can send an alert to the cell phone of the child's parent. The processor can detect when the selected device is activated by detecting when the device begins making non-automated outgoing requests. Non-automated requests are characterized by significant traffic in user clients like browsers. The type of client is determined by examining User Agent of the HTTP requests. Significant traffic is determined by data rate.

The router configured to monitor the network traffic on a home network can include computer instructions for identifying the device hardware an operating system, as well as a browser type.

The computer instructions for identifying the device hardware, an operating system, and a browser type can instruct the processor to examine the user agent of the outgoing HTTP requests. For example, these computer instructions can instruct the processor to inspect the User Agent, which is a header field in the HTTP request, parse the field to obtain the browser, operating system, and device type parsing the field, and associate the extracted information with the device in a database or report that is available to a user upon request.

The router configured to monitor the network traffic on a home network can include computer instructions for Network Address Translation (NAT) traversal.

The computer instruction for NAT traversal can instruct the processor to contact a relay server in the public internet which attempts to call back to the router. If a NAT is intervening, the computer instructions for NAT traversal can instruct the processor to determine the type of NAT and apply the appropriate NAT traversal algorithm. The computer instructions for NAT traversal can instruct the processor to use a Universal Plug and Play (UPnP) to request port forwarding to the external address of the router. In another embodiment, the computer instructions for NAT traversal can instruct the processor to request a firewall pinhole. The computer instructions for NAT traversal can use additional NAT traversal protocols including Session Traversal Utilities for NAT (STUN), which maintains a usable external address through multiple layers of NAT of certain types, and Traversal Using Relays around NAT (TURN), which actually relays data where an external address isn't sufficient.

The personal device configured to communicate with the router can be a mobile phone, a laptop, a mobile processor, such as a tablet, a personal computer, similar devices, or combinations thereof.

The personal device configured to communicate with the router can include computer instructions to communicate with the router through the local area network or another network by traversing the NAT on which the Local Area Network (LAN) may be connected, as well as to the general Internet, including cell networks.

The computer instructions to communicate with the router through the local area network or another network by traversing the NAT on which the LAN may be connected to the general Internet, including cell networks, can allow the client to contact the relay to query the address or addresses by which to contact the router.

The personal device configured to communicate with the router can include computer instructions to display identifying information for a device in communication with the router.

The computer instructions to display identifying information for a device in communication with the router can instruct the personal device processor to receive and display information captured for each device on the network. The information can be displayed graphically in line or bar charts.

The personal device configured to communicate with the router can include computer instructions to display QoS settings for the device in communication with the router.

The computer instructions to display QoS settings for the device in communication with the router can instruct the personal device processor to communicate with the router to determine the QoS for each device on the network and display the information on the personal device.

The personal device configured to communicate with the router can include computer instructions to adjust QoS settings for a device in communication with the router.

The computer instructions to adjust QoS settings for a device in communication with the router can instruct the processor to receive input from a user such as a double click, a squeeze on a touch screen, a tap on a touch screen, a click and drag, or other input to adjust the allowable data rate for each device on the network.

For example, the personal device configured to communicate with the router can include computer instructions to allow manipulation of the graphical display to control the data rates for the device and change the QoS setting of the device in communication with the router.

The computer instructions to allow manipulation of the graphical display to control the data rates for the device and change the QoS setting of the device in communication with the router can provide pairs of vertical sliders for each device. The vertical sliders can be calibrated and adjacent to the line or bar graph for all devices. The vertical sliders can be calibrated to the vertical range of the line or bar graph and used to set minimums and maximums for the data traffic of the devices associated therewith. The result of manipulating the vertical sliders can be observed in real time in the line or bar graph, not only for the device being manipulated but for the other devices that share the bandwidth on the router. In one or more embodiments, the computer instructions can provide single sliders for each device next to the shared line or bar graph for all devices that set relative priorities of the traffic for each device.

As above the result of manipulating the sliders can be observed in real time in the graphs. These computer instructions can do one of the foregoing or can do both.

The personal device configured to communicate with the router can include computer instructions to program and receive an event on the router, such as when a LAN device comes into use.

The computer instructions to program and receive an event on the router, such as when a LAN device comes into use, can instruct the personal device processor to communicate with the router and to relay inputs on one or more alerts desired by a user, and then instruct the router to send an alert, such as a visual or audio alert, when one or more of relayed desired inputs occur.

The personal device configured to communicate with the router can include computer instructions to graphically display real-time and historical data rates of the device in communication with the router.

The computer instructions to graphically display real-time and historical data rates of the device in communication with the router can instruct the personal device processor to receive real-time and historical data rates from the router, and to display the real-time and historical data rates on the personal device.

The personal device configured to communicate with the router can include computer instructions to display a list of web addresses requested from the device in communication with the router.

The computer instructions to display a list of web addresses requested from the device in communication with the router can instruct the personal device to communicate with the router to receive a list of web addresses requested from a device on the network, and to display the list on the personal device.

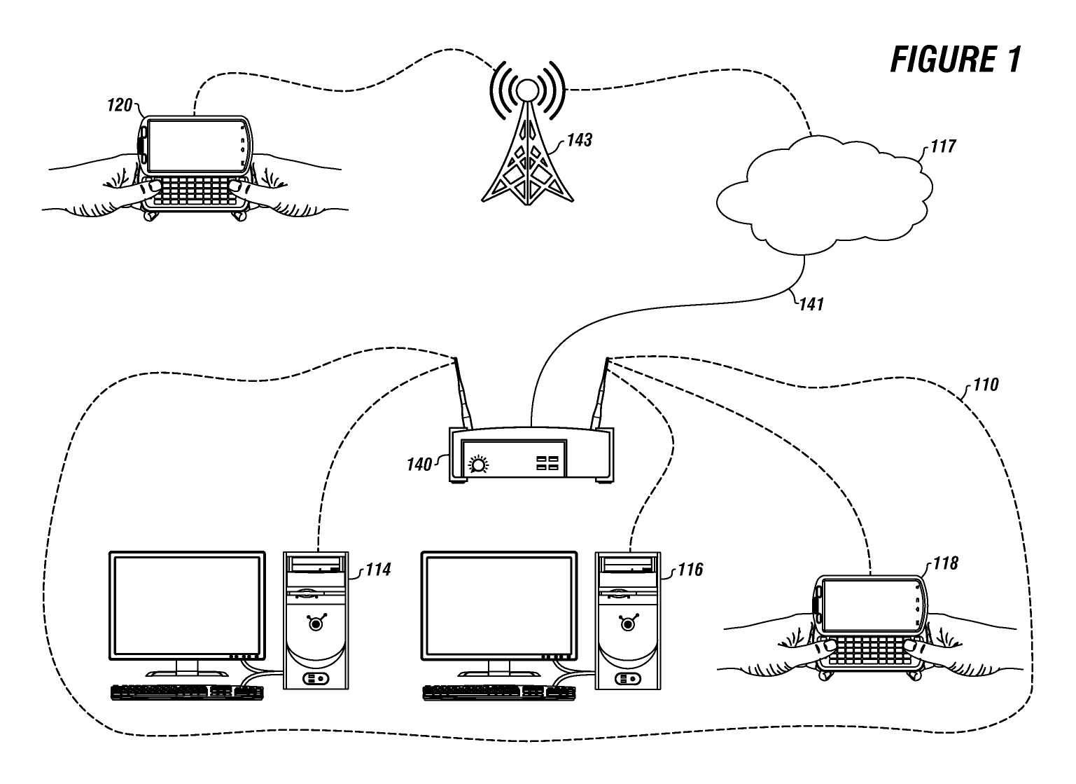

Turning now to the Figures, FIG. 1 depicts a schematic of a system with a router configured to monitor traffic on a network and two personal devices configured to communicate with the router according to one or more embodiments. The system can include a local area network 110 and a wide area network 117.

The local area network 110 can include a router 140, a first device 114, a second device 116, and a first personal device 118. The router 140 can communicate with the wide area network 117 and the devices 114, 116, and 118 via a cable modem or Digital Subscriber Line (DSL) 141. The devices 114, 116, 118 can be in communication with the wide area network 117 via the router 140. The devices 114 and 116 can be any device. For example, the devices 114 and 116 can be personal computers, gaming consoles, Blu-ray players, laptops, mobile phones, other devices configured to communicate with the local area network, or combinations thereof.

A second personal device 120 can communicate with the router 140 using a network external from the local area network 110, such as cell network 143. The network external from the local area network 110 can be a cellular network, a wide area network 117, or the like.

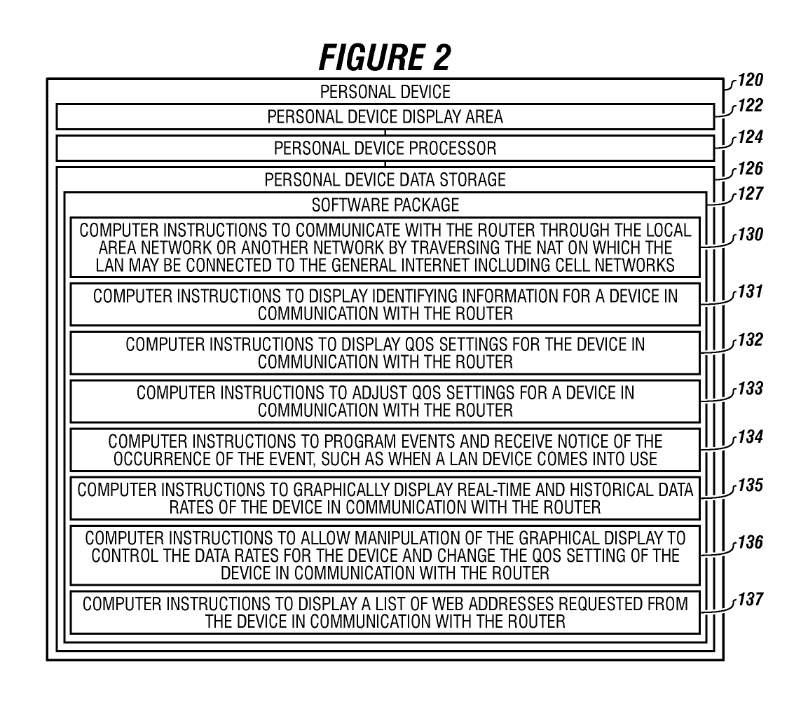

The personal devices 118 and 120 can be any device that is configured to communicate with the router, display information from the router, and monitor and control the data rates for all devices on the local area network. For example, a software package or application similar to that disclosed in FIG. 2 can be downloaded on a device to form a personal device. Illustrative devices that can have the software downloaded thereon can include tablets, personal computers including desktops and laptops, phones, and combinations thereof.

FIG. 2 depicts a schematic of a personal device configured to communicate with a router according to one or more embodiments. The personal devices can be any devices transformed into personal devices by the programming provided by the software package 127.

The personal device 120 can include a personal device display area 122, a personal device processor 124, and a personal device data storage 126.

The personal device data storage 126 can have the software package 127 stored thereon. The software package 127 can include a plurality of computer instructions.

The software package 127 can include computer instructions to communicate with the router through the local area network or another network by traversing the NAT on which the LAN may be connected to the general Internet including cell networks 130.

The software package 127 can include computer instructions to display identifying information for a device in communication with the router 131.

The software package 127 can include computer instructions to display QoS settings for the device in communication with the router 132.

The software package 127 can include computer instructions to adjust QoS settings for a device in communication with the router 133.

The software package 127 can include computer instructions to program events and receive notice of the occurrence of the event, such as when a LAN device comes into use 134.

The software package 127 can include computer instructions to graphically display real-time and historical data rates of the device in communication with the router 135.

The software package 127 can include computer instructions to allow manipulation of the graphical display to control the data rates for the device and change the QoS setting of the device in communication with the router 136.

The software package 127 can include computer instructions to display a list of web addresses requested from the device in communication with the router 137.

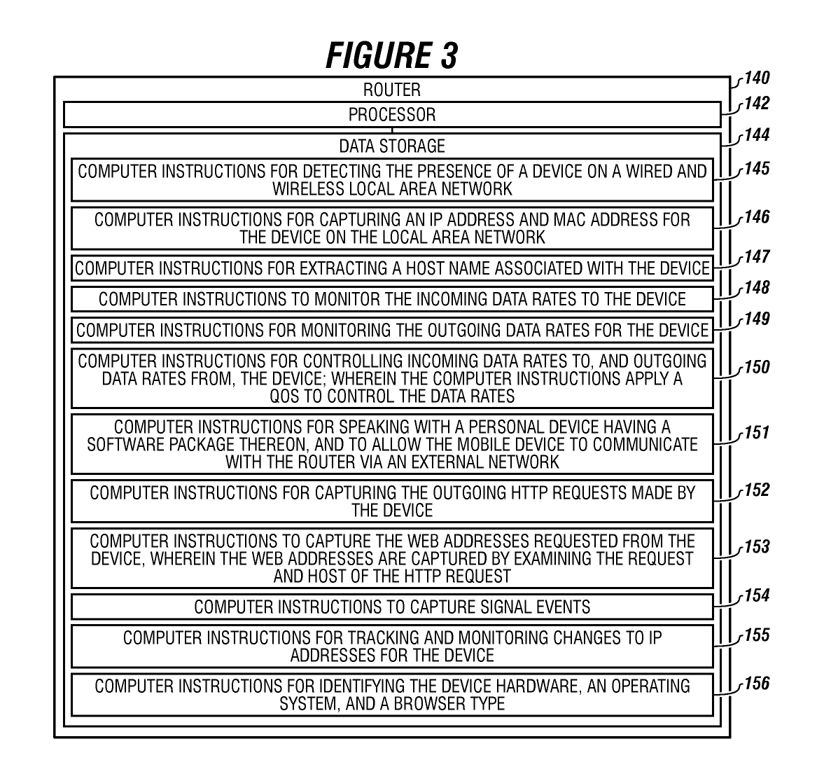

FIG. 3 depicts a schematic of a router configured to monitor traffic on a network according to one or more embodiments. The router 140 can include a processor 142 and a data storage 144.

The data storage 144 can include a plurality of computer instructions.

The data storage 144 can include computer instructions for detecting the presence of a device on a wired and wireless local area network 145.

The data storage 144 can include computer instructions for capturing an IP address and MAC address for the device on the local area network 146.

The data storage 144 can include computer instructions for extracting a host name associated with the device 147.

The data storage 144 can include computer instructions to monitor the incoming data rates to the device 148.

The data storage 144 can include computer instructions for monitoring the outgoing data rates for the device 149.

The data storage 144 can include computer instructions for controlling incoming data rates to, and outgoing data rates from, the device; wherein the computer instructions apply a QoS to control the data rates 150.

The data storage 144 can include computer instructions for speaking with a personal device having a software package thereon, and to allow the mobile device to communicate with the router via an external network 151. These computer instructions can instruct the router to contact a relay server in the public internet, which attempts to call back to the router. If a NAT is intervening, the type of NAT is determined and the appropriate NAT traversal algorithm is applied. For example, these computer instructions can instruct the processor to use an UPnP to request a port forwarding to the external address of the router, and a firewall pinhole may also be requested. Additional NAT traversal protocols can include STUN, which maintains a usable external address through multiple layers of NAT of certain types, and TURN, which actually relays data where an external address isn't sufficient.

The data storage 144 can include computer instructions for capturing the outgoing HTTP requests made by the device 152.

The data storage 144 can include computer instructions to capture the web addresses requested from the device, wherein the web addresses are captured by examining the request and host of the HTTP request 153.

The data storage 144 can include computer instructions to capture signal events 154.

The data storage 144 can include computer instructions for tracking and monitoring changes to IP addresses for the device 155.

The data storage 144 can include computer instructions for identifying the device hardware, an operating system, and a browser type 156.

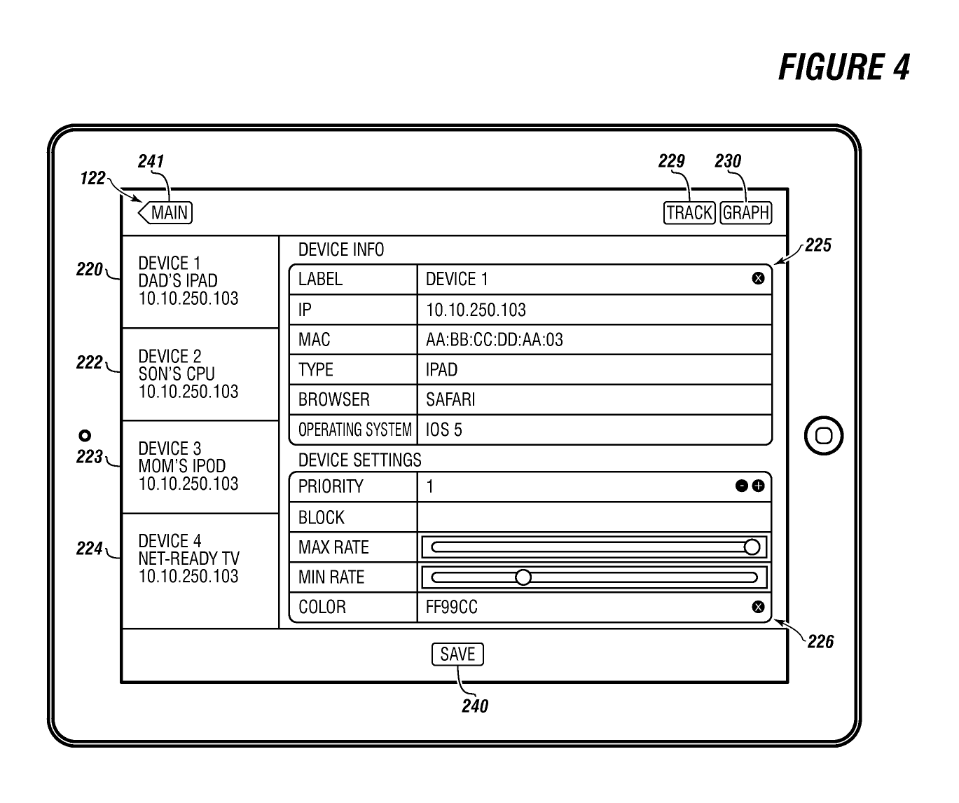

FIG. 4 depicts a schematic of a personal device display area according to one or more embodiments.

The personal device display area 122 can display a control module for one of the devices.

The personal device display area 122 can include device boxes 220, 222, 223, and 224. The device boxes 220, 222, 223, and 224 can display information for an associated device. For example, the device box can display one or more of a name assigned to the device, a type of device, IP address for the device, an operating system for the device, a browser used by the device, the like, or combinations thereof.

The personal device display area 122 can also include a parent device information section 225. The parent device information section 225 can display the information for a selected device. The device can be selected by clicking the device boxes 220, 222, 223, and 224. The parent device information section 225 can be used to change the label of the device, add a type of device, if not already known, and will also display information on the device gathered via the router such as the MAC and IP addresses.

The personal device display area 122 can also include a device setting section 226. The device setting section 226 can also include a user to set a maximum data rate for the selected device; a minimum data rate for the selected device; a priority for the selected device; and an indicator, which can be displayed in legends on graphical depictions; for the selected device. The indicator can be a color, a shading, a line style, or the like.

The user can use the track button 229 to track data rates for the selected device, track HTTP requests for the selected device, track when a selected device is turned on or off, or the like. The user can use the graph button 230 to see data rate graphs for the selected device, all devices, or a plurality of devices. The user can click the main button 241 to access a main menu. A save button 240 can be used to save the device settings, device information, or combinations thereof.

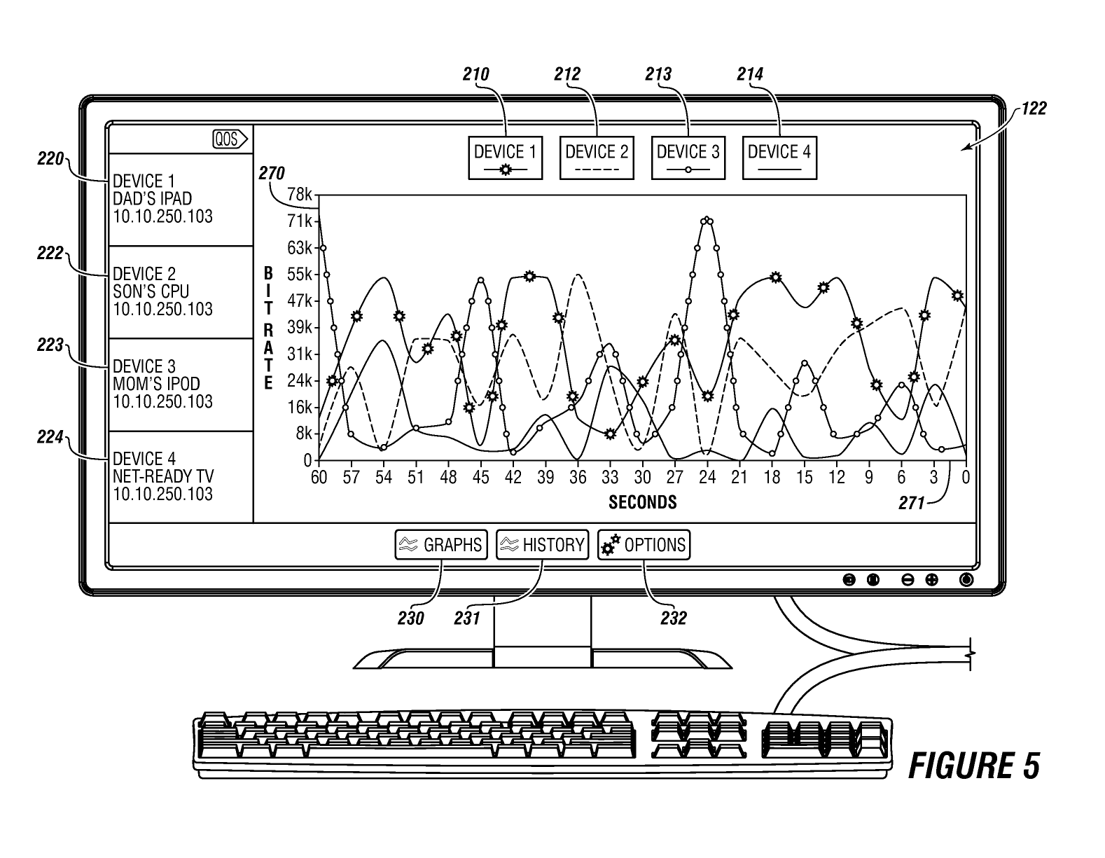

FIG. 5 depicts a schematic of a display depicting real time traffic in a sliding window display according to one or more embodiments.

The personal device display area 122 can also include the device boxes 220, 222, 223, and 224.

The personal device display area 122 can include a graphical display of data rate used for each device. The display can have an x-axis 271 representing time and a y-axis 270 bit rate.

The personal device display area 122 can also include device identifiers 210, 212, 213, and 214. The device identifiers 210, 212, 213, and 214 can allow a user to determine which curve represents which device is being depicted in the graphical display. The device identifiers can be any legend to identify each device such as shading of the area formed by the graph of the data rate transfers, different shaped lines, different colored lines, or any other identifier.

The user can use the graphs button 230 to select the graphs he wants to view, the history button 231 to see data rate or device histories, or options button 232 to select options for the displayed graph.

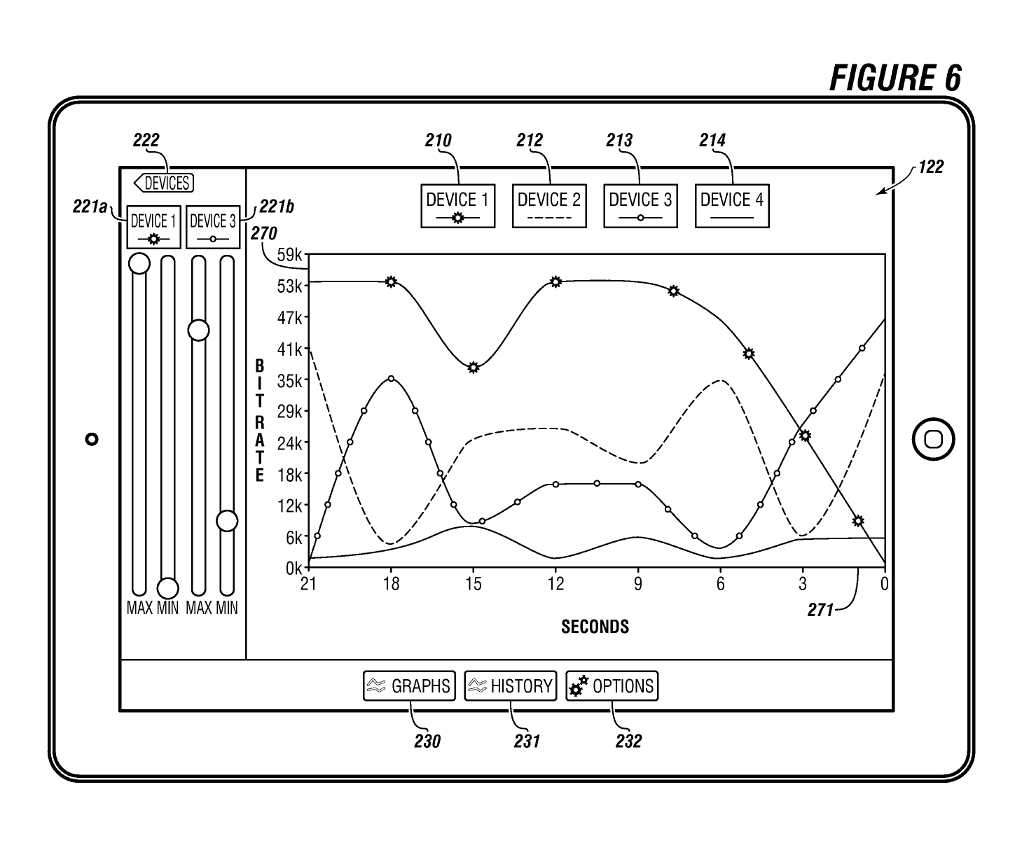

FIG. 6 depicts a schematic of another embodiment of the personal device display area according to one or more embodiments.

The personal device display area 122 can depict the data usage for each device using a graph. The personal device display area 122 can depict the device identifiers 210, 212, 213, and 214, the y-axis 270, the x-axis 271, the graphs button 230, the history button 231, and the options button 232. The first device set of vertical scales 221a can be associated with a first device, and a third device set of vertical scales 221b can be associated with a third device. A user can scroll through the devices using the devices button 222. In one or more embodiments, the set of vertical scales can be placed on a carousel and a user can simple move or shuffle through devices by moving the set of vertical scales left or right. One or more sets of vertical scales can be displayed at one time. The first device set of vertical scales 221a can be moved up or down to set the maximum data transfer rate and minimum data transfer rate for the first device, and the third device set of vertical scales 221b can be moved up or down to set the maximum data transfer rate and minimum data transfer rate the third device. The maximum and minimum data transfer rates can be set automatically to a default position based on default or previously set rate of the devices. The default rate can be set in a screen such as that depicted in FIG. 4.

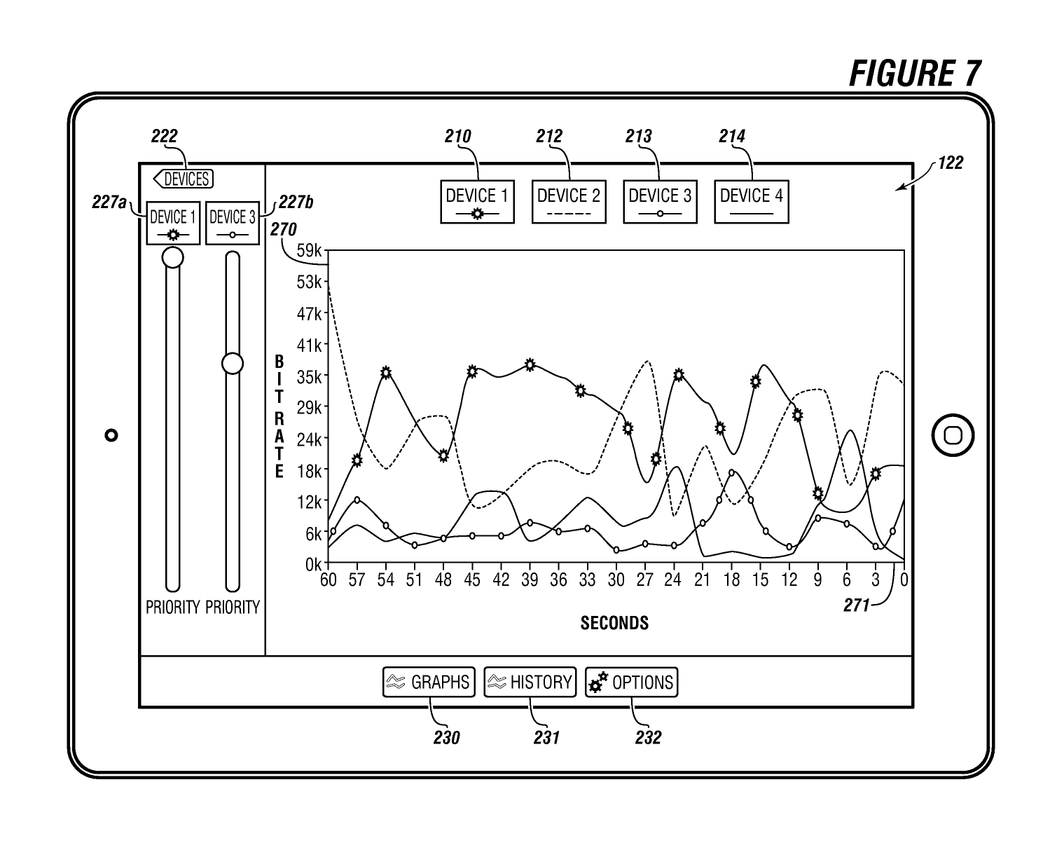

FIG. 7 depicts a schematic of yet another embodiment of the display of the personal device according to one or more embodiments.

The personal device display area 122 can depict the data usage for each device using a graph. The personal device display area 122 can depicts the device identifiers 210, 212, 213, and 214, the y-axis 270, the x-axis 271, the graphs button 230, the history button 231, and the options button 232.

The first device vertical priority slider 227a and the third device vertical priority slider 227b can be adjusted up or down to set the priority of the associated device within the QoS settings. For example, the first device vertical priority slider 227a can be adjusted to set the priority within the QoS for the first device identified in the first device box 220. The devices button 222 can be used to scroll through devices. The devices can have their associated vertical priority sliders automatically set based on default or previously set priorities of the devices. In one or more embodiments, the vertical priority sliders can be placed on a carousel and a user can simple shuffle through devices by sliding or moving the vertical priority sliders left or right. The default priorities can be set in a screen such as that depicted in FIG. 4.

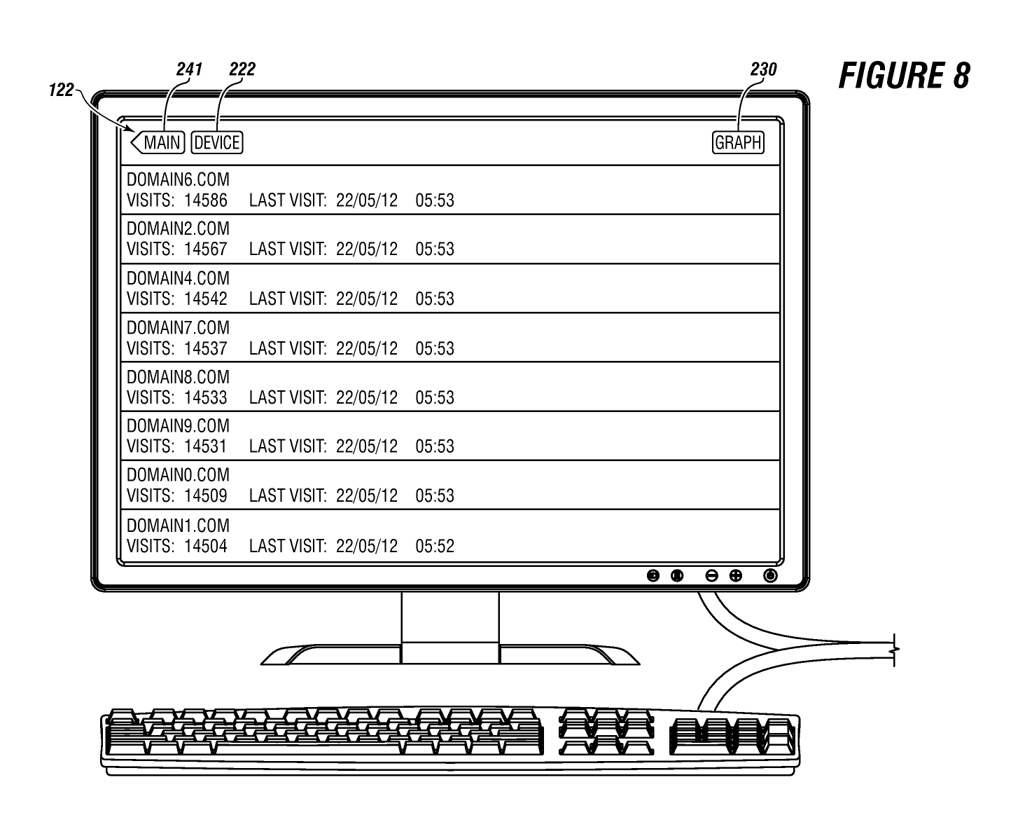

FIG. 8 depicts the display showing a list of web addresses for a given device.

The router can be instructed to track domains visited by a selected device. The personal device display area 122 can display a list of web addresses in domain only view, as depicted, or in complete address view. The time spent at the domain, the times visited, the dates visited, the time spent on the domain or combinations thereof can also be displayed.

The user can use the main button 241 to return to a main menu. The user can use the graph button 230 to select to view a graph for the selected device, one or more devices, or a plurality of devices. The user can also use the devices button 222 to be sent to a page, such as that depicted in FIG. 4.

While these embodiments have been described with emphasis on the embodiments, it should be understood that within the scope of the appended claims, the embodiments might be practiced other than as specifically described herein.

What is claimed is:

1. A router configured to monitor the network traffic on a home network, wherein the apparatus comprises:
a. computer instructions for detecting the presence of a device on a wired and wireless local area network;
b. computer instructions for capturing a IP address and MAC address for the device on the local area network;
c. computer instructions for extracting a host name associated with the device;
d. computer instructions to monitor the incoming data rates to the device;
e. computer instructions for monitoring the outgoing data rates for the device;
f. computer instructions for controlling incoming data rates to and outgoing data rates from the device; wherein the computer instructions apply a QoS to control the data rates; and
g. computer instructions for speaking with a personal device having a software package thereon, wherein the software package enables the mobile device to control and monitor.

2. The router of claim 1, further comprising computer instructions for capturing the outgoing HTTP requests made by the device.

3. The router of claim 2, further comprising computer instructions to capture the web addresses requested from the device, wherein the web addresses are captured by examining the request and host of the HTTP request.

4. The router of claim 1, further comprising computer instructions to capture signal events.

5. The router of claim 1, further comprising computer instructions for tracking and monitoring changes to IP addresses for the device.

6. The router of claim 1, wherein the personal device is a mobile phone, a lap top, a mobile processor, a personal computer, or combinations thereof.

7. The router of claim 1, further comprising computer instructions for identifying the device hardware, an operating system, and a browser type.

8. The router of claim 1, wherein the router further comprises: computer instructions for NAT traversal, wherein the computer instructions for NAT traversal can instruct the processor to establish a NAT traversal mechanism and address by interacting with a relay in the public network and publishing this to the relay.

9. A personal device configured to communicate with a router wherein the personal device comprises:
a. computer instructions to communicate with the router through the local area network or another network by traversing the NAT on which the LAN may be connected to the general Internet including cell networks;
b. computer instructions to display identifying information for a device in communication with the router;
c. computer instructions to display QoS settings for the device in communication with the router;
d. computer instructions to adjust QoS settings for a device in communication with the router;
e. computer instructions to programming and receipt of event on the router such as when a LAN device comes into use;
f. computer instructions to graphically display real-time and historical data rates of the device in communication with the router;
g. computer instructions to allow manipulation of the graphical display to control the data rates for the device and change the QoS setting of the device in communication with the router; and
h. computer instructions to display a list of web addresses requested from the device in communication with the router.

10. The personal device of claim 1, wherein the personal device is a mobile phone, a lap top, a mobile processor, a personal computer, or combinations thereof.
